(19) United States
(12) Patent Application Publication
(10) Pub. No.: US 2024/0217380 A1
(43) Pub. Date: Jul. 4, 2024

(54) Wireless Charging-Based Underwater Energy Rescue Method for Autonomous Underwater Vehicle (AUV) Cluster

(71) Applicant: Shenzhen Technology University, Shenzhen (CN)

(72) Inventors: Xiaolin MOU, Shenzhen (CN); Zhengji FENG, Shenzhen (CN); Disha YANG, Shenzhen (CN); Heyan LI, Shenzhen (CN); Franz RAPS, Shenzhen (CN)

(73) Assignee: Shenzhen Technology University, Shenzhen (CN)

(21) Appl. No.: 18/605,876

(22) Filed: Mar. 15, 2024

Related U.S. Application Data
(63) Continuation of application No. PCT/CN2023/099601, filed on Jun. 12, 2023.

(30) Foreign Application Priority Data
Oct. 27, 2022 (CN) 202211325065.4

(51) Int. Cl. B60L 53/67; B60L 53/12; B60L 53/57; B60L 53/65; B60L 53/66; B63G 8/00

(52) U.S. Cl. CPC B60L 53/67; B60L 53/12; B60L 53/57; B60L 53/65; B60L 53/66; B63G 8/001; B60L 2200/32

(57) ABSTRACT

A wireless charging-based underwater energy rescue method for an autonomous underwater vehicle (AUV) cluster fully considers the actual situation of an AUV rescue system. For example, a rescue-side AUV takes speed as a constraint in order for rapid rescue, while a demand-side AUV takes minimum energy consumption as a constraint to select an optimal charging point. In addition, optimal path planning is performed in an environment with a dynamic disturbance such as a fish school. The wireless charging-based underwater energy rescue method combines path planning algorithms, namely rapidly-exploring random trees (RRT) and dynamic window approach (DWA), to achieve rapid and effective underwater energy rescue of AUVs.

### CROSS REFERENCE TO THE RELATED APPLICATIONS

This application is the continuation application of International Application No. PCT/CN2023/099601, filed on Jun. 12, 2023, which is based upon and claims priority to Chinese Patent Application No. 202211325065.4, filed on Oct. 27, 2022, the entire contents of which are incorporated herein by reference.

### TECHNICAL FIELD

The present disclosure relates to the technical field of underwater wireless rescue, and in particular to a wireless charging-based underwater energy rescue method for an autonomous underwater vehicle (AUV) cluster.

### BACKGROUND

In coastal areas of China, a country with vast sea areas, the economy is rapidly developing, the population is gradually increasing, and the scale of marine development is constantly expanding. In this context, the protection and sustainable development of the ocean have become a key strategic development direction for China. Marine technological innovation is an important pillar for high-quality development of marine economy.

With the development of science and technology, autonomous underwater vehicles (AUVs) hold a particularly important strategic position in fields such as deep-sea exploration and underwater rescue. However, due to the limitations of battery energy storage, the operating time of AUVs is usually short, and charging in underwater environments is difficult, requiring a closed (water-tight) state. Wireless charging technology can effectively solve the energy supply problem of AUVs, and wireless charging-based energy interaction can achieve energy rescue of individual AUVs in an AUV cluster.

In an underwater wireless rescue system of an AUV cluster, energy matching is performed between a demand-side AUV and a rescue-side AUV, and after energy matching, path planning is performed for the matched demand-side AUV and rescue-side AUV. At present, research on path planning of AUVs is relatively scarce, mainly due to the complex underwater environment. The present disclosure fully considers the actual situation of the AUV rescue system, and combines path planning algorithms, namely dynamic bidirectional heuristic rapidly-exploring random trees (DBH-RRT*) and dynamic window approach (DWA), to achieve rapid and effective AUV energy rescue.

### SUMMARY

In view of the above-mentioned problems, the present disclosure provides a wireless charging-based underwater energy rescue method for an autonomous underwater vehicle (AUV) cluster.

To achieve the above objective, the present disclosure provides the following technical solution.

An aspect of the present disclosure provides a wireless charging-based underwater energy rescue method for an AUV cluster.

The wireless charging-based underwater energy rescue method for an AUV cluster includes the following steps:
S1: issuing, by a demand-side AUV, a charging request through a device thereof;
S2: extracting, by a cloud controller, information of the demand-side AUV, where the information of the demand-side AUV includes an underwater geographic location, an estimated mileage to a destination, and a travel efficiency;
S3: retrieving, by the cloud controller, information of a rescue-side AUV that is at a certain distance from the demand-side AUV and allowed to provide a charging service, based on a location of the demand-side AUV, where the information of the rescue-side AUV includes an underwater geographic location, an estimated mileage, a travel efficiency, and battery information;
S4: calculating a distance between the demand-side AUV and each rescue-side AUV in a sample;
S5: calculating energy required by the demand-side AUV;
S6: calculating a difference between energy available from the rescue-side AUV and the energy required by the demand-side AUV;
S7: selecting a sample of all rescue-side AUVs with an energy difference greater than 0 as a candidate sample of rescue-side AUVs; and
S8: performing global path planning through a three-dimensional dynamic bidirectional heuristic rapidly-exploring random trees (3D-DBH-RRT*) algorithm, and performing local path planning through a dynamic window approach (DWA) algorithm, to achieve real-time obstacle avoidance and find an optimal rescue path.

Further, in step S2, the information of the demand-side AUV further includes: a battery level required by the demand-side AUV to reach the destination, and a serial number, a speed, and an attitude of the demand-side AUV.

Further, in step S3, the information of the rescue-side AUV further includes: a battery level available from the rescue-side AUV, and a serial number, a speed, and an attitude of the rescue-side AUV.

Further, in step S8, the step of performing global path planning through the 3D-DBH-RRT* algorithm includes: running an RRT* algorithm with the rescue-side AUV as a starting point and the demand-side AUV as an endpoint, then, running the RRT* algorithm again with the demand-side AUV as a starting point and the rescue-side AUV as an endpoint, and adding a heuristic function to quickly find a feasible path and continuously optimizing the path to approach a shortest path; where map and path information is shared between the rescue-side AUV and the demand-side AUV.

Further, step S8 includes: deploying the DWA algorithm on the demand-side AUV and the rescue-side AUV, respectively, where the DWA algorithm deployed on the rescue-side AUV includes a rapid mode and a power-saving mode; the DWA algorithm deployed on the demand-side AUV includes a power-saving mode and is only run when no new feasible path within a limit distance between the demand-side AUV and the rescue-side AUV is found through the 3D-DBH-RRT* algorithm; and the limit distance is expressed as:

$$\sqrt{{( {A}_{x} - {O}_{x} )}^{2} + {( {A}_{y} - {O}_{y} )}^{2}} = \frac{{d}_{1} + {d}_{2}}{2}$$

where, d₁ denotes a diameter of an AUV model, and is a diameter of a smallest circle centered on a geometric center P_{AUV}=(Aₓ, A_{y}) of the AUV model and covering the AUV model; d₂ denotes an inflation distance of an obstacle, d₂=r₁+r₂; r₁ denotes a radius of a smallest circle centered on P_{OB}=(Oₓ, O_{y}) and covering the obstacle; and r₂ denotes a radius of the AUV model.

Further, in step S8, the 3D-DBH-RRT* algorithm deployed on the rescue-side AUV includes: re-planning a path with a current coordinate as a starting point and the demand-side AUV as an endpoint when a path planned by the rescue-side AUV encounters an obstacle; running, if no feasible path is found before the rescue-side AUV reaches the obstacle, the DWA algorithm to achieve dynamic obstacle avoidance; and replacing an original path if a feasible path is found.

Further, the 3D-DBH-RRT* algorithm is initialized before the rescue-side AUV departs.

Further, in step S8, the 3D-DBH-RRT* algorithm deployed on the demand-side AUV includes: activating the power-saving mode; sampling and searching only when the rescue-side AUV is within a rescue radius (a maximum distance that the demand-side AUV continues to move based on a current battery level thereof); dynamically improving a path while avoiding a dynamic obstacle; and synchronizing map and path information between the demand-side AUV and the rescue-side AUV, where the rescue radius is denoted as

$$s = V \frac{W}{P} ;$$

W denotes a current battery level of the demand-side AUV; P denotes a minimum power; and V denotes a speed corresponding to the minimum power.

Compared with the prior art, the present disclosure has the following beneficial effects:

The present disclosure proposes a wireless charging-based underwater energy rescue method for an AUV cluster. The present disclosure is based on decoupling representation and fully considers the actual situation of the AUV rescue system. For example, the rescue-side AUV takes speed as a constraint in order for rapid rescue, while the demand-side AUV takes minimum energy consumption as a constraint to select the optimal charging point. In addition, optimal path planning is performed in environments with dynamic disturbances such as fish schools. The present disclosure combines path planning algorithms RRT* and DWA to achieve rapid and effective underwater energy rescue of AUVs.

### BRIEF DESCRIPTION OF THE DRAWINGS

To illustrate the embodiments of the present application or the technical solutions in the prior art more clearly, the drawings required in the embodiments will be briefly introduced below. Apparently, the drawings in the following description show merely some embodiments of the present disclosure, and those of ordinary skill in the art may still derive other drawings from these drawings.

FIG. 1 shows an application scenario of a wireless charging-based underwater energy rescue method for an AUV cluster according to an embodiment of the present disclosure;

FIG. 2 is a flowchart of the wireless charging-based underwater energy rescue method for an AUV cluster according to an embodiment of the present disclosure;

FIG. 3 is a flowchart of path planning algorithms of the wireless charging-based underwater energy rescue method for an AUV cluster according to an embodiment of the present disclosure;

FIG. 4 is a flowchart of a DWA algorithm of the wireless charging-based underwater energy rescue method for an AUV cluster according to an embodiment of the present disclosure;

FIG. 5 shows a path planned for an AUV in an ideal working condition according to an embodiment of the present disclosure;

FIG. 6 shows a path planned in case a demand-side AUV fails to avoid an obstacle in a timely manner (the demand-side AUV is trapped by the obstacle) according to an embodiment of the present disclosure;

FIG. 7 shows a limit distance according to an embodiment of the present disclosure; and

FIG. 8 shows an effect of a 3D-DBH-RRT* algorithm according to an embodiment of the present disclosure.

### DETAILED DESCRIPTION OF THE EMBODIMENTS

To better understand the technical solutions, the foregoing describes in detail a method in the present disclosure with reference to the drawings.

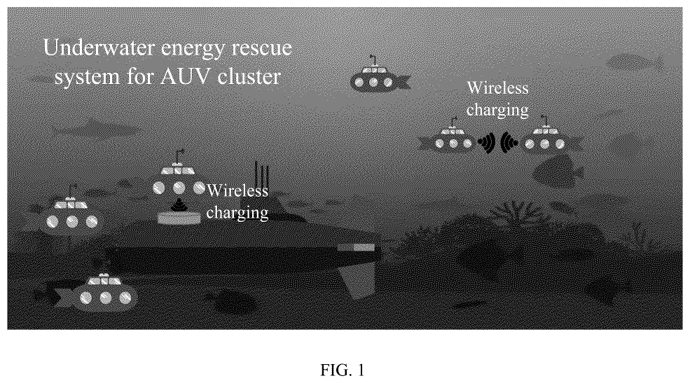

The present disclosure proposes an underwater wireless charging-based energy interaction model for an AUV cluster and a path planning optimization method for an AUV cluster in an environment with a dynamic disturbance such as fish schools. As shown in FIG. 1, a demand-side AUV is intended to reach a destination, but the demand-side AUV's battery level is below a threshold (such as only 20%), which is not enough for the demand-side AUV to reach the destination. Therefore, the demand-side AUV issues a charging request through a device thereof. An energy interaction model searches for and matches a suitable rescue-side AUV based on a geographic location (underwater location) of the demand-side AUV, in order to provide nearby energy supply for the demand-side AUV.

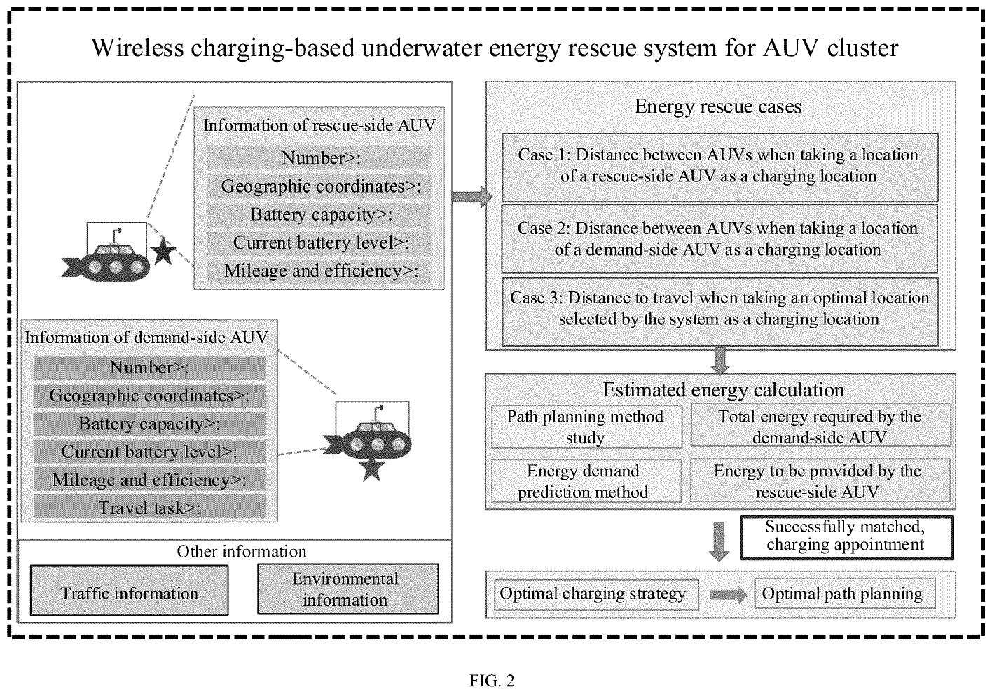

The present disclosure provides a wireless charging-based underwater energy rescue method for an AUV cluster. As shown in FIG. 2, the wireless charging-based underwater energy rescue method specifically includes the following steps.

S1. When a demand-side AUV has a low battery level (less than a threshold, for example 20%), the demand-side AUV issues a charging request through a device thereof.

S2. A cloud controller extracts information of the demand-side AUV.

The information of the demand-side AUV includes:
an underwater geographic location (longitude, latitude, depth); an estimated mileage to reach a destination; a battery level required by the demand-side AUV to reach the destination; and
a serial number, a speed, an attitude, and a travel efficiency of the demand-side AUV.

S3. The cloud controller retrieves information of a rescue-side AUV that is at a certain distance from the demand-side AUV and allowed to provide a charging service, based on a location of the demand-side AUV.

The information of the rescue-side AUV includes:
an underwater geographic location (longitude, latitude, depth); an estimated mileage to travel; an available battery level; a serial number, a speed, an attitude, and a travel efficiency of the rescue-side AUV; and battery information (total battery capacity, discharge depth, cycle life) of the rescue-side AUV.

A customized variable of the energy rescue model includes:
a charging mode: wireless charging efficiency.

The energy rescue model finds an appropriate rescue-side AUV. The specific process is as follows:

S4. A distance between the demand-side AUV and each rescue-side AUV in a sample is calculated.

S5. Energy required by the demand-side AUV is calculated.

S6. A difference between energy available from the rescue-side AUV and the energy required by the demand-side AUV is calculated.

S7. A sample of all rescue-side AUVs with an energy difference greater than 0 is selected as a candidate sample of rescue-side AUVs.

S8. Global path planning is performed through a three-dimensional dynamic bidirectional heuristic rapidly-exploring random trees (3D-DBH-RRT*) algorithm, and local path planning is performed through a dynamic window approach (DWA) algorithm, to achieve real-time obstacle avoidance and find an optimal rescue path.

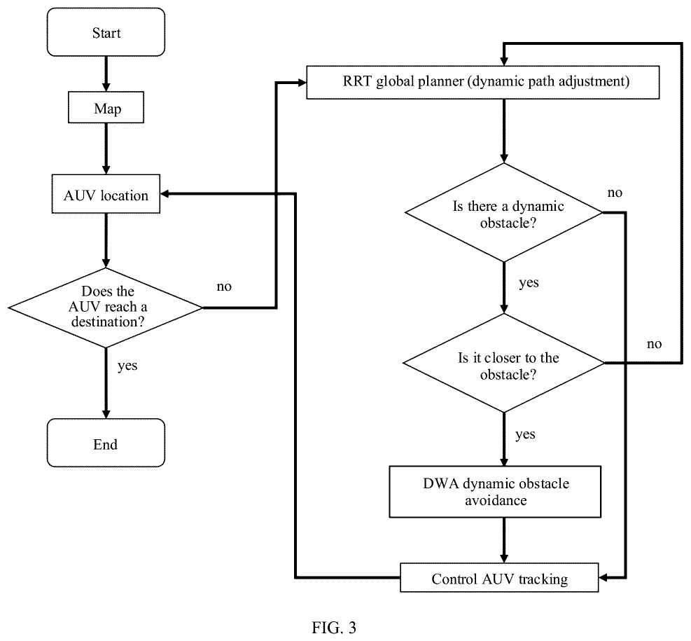

The path planning of the underwater energy rescue system for the AUV cluster is shown in FIG. 3. The DWA algorithm is combined with the 3D-DBH-RRT* algorithm to perform multi-objective path planning in a complex dynamically disturbing underwater environment. In addition, the 3D-DBH-RRT* algorithm can select the optimal path that meets the requirement of underwater wireless energy rescue. The battery level of the demand-side AUV is taken as a constraint for the path planning of the demand-side AUV, such that the demand-side AUV with the remaining energy can meet with the rescue-side AUV through the optimal path. The speed of the rescue-side AUV is taken as a constraint for the path planning of the rescue-side AUV, such that the rescue-side AUV can provide rescue at the rapidest speed. During this process, the rescue-side AUV and the demand-side AUV both need to perfectly avoid the obstacle (such as fish schools).

Specifically, the path planning includes global path planning and local path planning. The global path planning is performed through a 3D-DBH-RRT* algorithm. Specifically, an RRT* algorithm is run with the rescue-side AUV as a starting point and the demand-side AUV as an endpoint. Then, the RRT* algorithm is run again with the demand-side AUV as a starting point and the rescue-side AUV as an endpoint. Finally, a heuristic function is added to quickly find a feasible path and the path is continuously optimized to approach a shortest path. Following the global path planning, the local path planning is performed through a DWA algorithm to find a feasible path and achieve a real-time obstacle avoidance function. The rescue-side AUV and the demand-side AUV share map and path information.

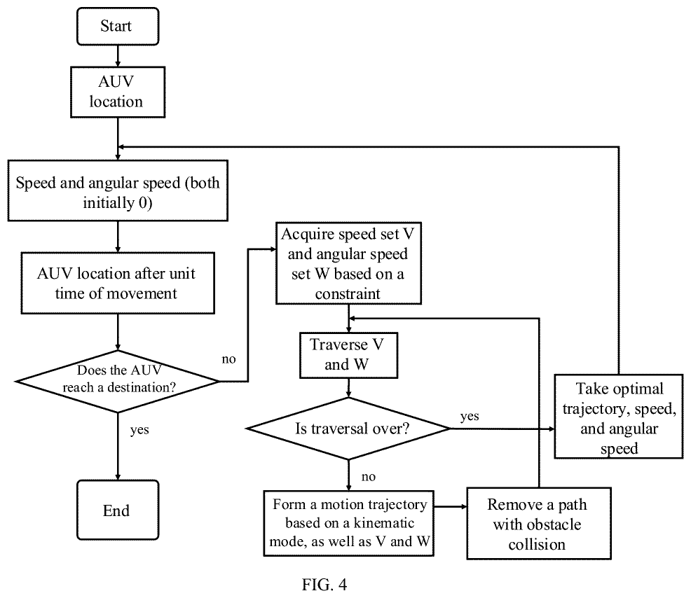

Through the DWA algorithm, the AUVs can cope with the dynamically disturbing underwater environment and avoid the obstacle such as fish schools in real-time. The DWA algorithm is deployed on the demand-side AUV and the rescue-side AUV, respectively. As shown in FIG. 4, the DWA algorithm is deployed on both the demand-side AUV and the rescue-side AUV.

The DWA algorithm deployed on the rescue-side AUV is described below.

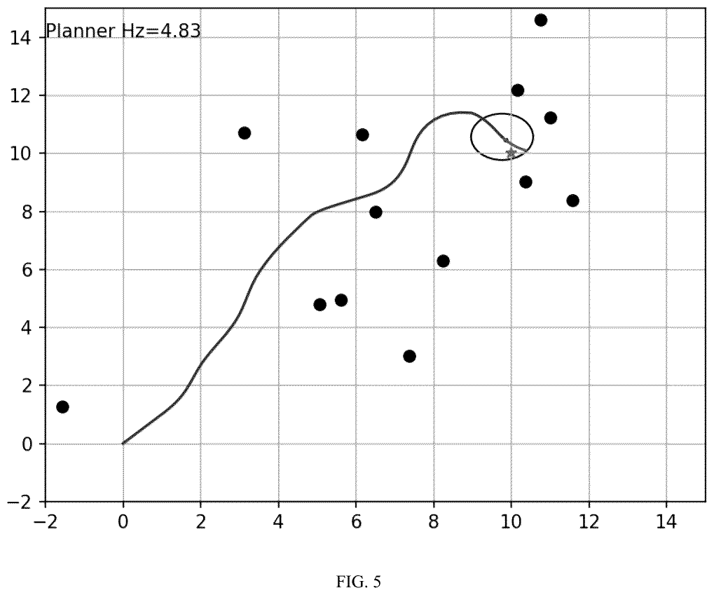

According to different requests from demand-side AUVs, the DWA algorithm includes a rapid mode and a power-saving mode. The rapid mode takes into account the performance limitations of the rescue-side AUV (such as maximum/minimum speed, maximum acceleration), and features good acceleration performance and rapid speed. The power-saving mode considers energy consumption limitations, and can reduce acceleration and maximum speed to achieve low-power and low-speed forwarding. An ideal working condition is shown in FIG. 5.

The DWA algorithm deployed on the demand-side AUV is described below.

The battery level of the demand-side AUVs is relatively low, only 20%. Therefore, the DWA algorithm deployed on the demand-side AUV only includes a power-saving mode.

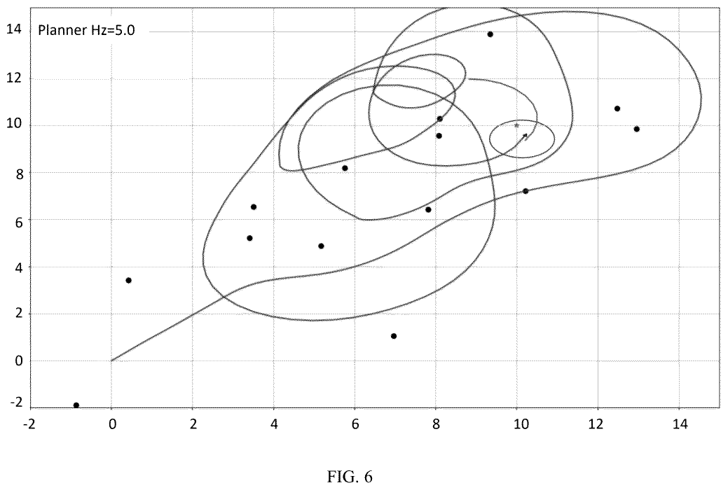

Only when no new feasible path within a limit distance is found through the 3D-DBH-RRT* algorithm for the rescue-side AUV and the demand-side AUV, the DWA algorithm runs on the demand-side AUV to avoid the obstacle in a timely manner and help the demand-side AUV meet with the rescue-side AUV. The design avoids the situation where the demand-side AUV is unable to meet with the rescue-side AUV due to being trapped by the obstacle (as shown in FIG. 6). In this situation, the rescue-side AUV may make go round and round to wait for the demand-side AUV to escape.

The 3D-DBH-RRT* algorithm deployed on the demand-side runs within the rescue radius. Therefore, first, a rescue radius (i.e. the maximum distance that the AUV continues to move) is denoted as s, which depends on a current battery level W of the AUV, a minimum power P, and a corresponding speed V at that power.

$$s = V t = V \frac{W}{P}$$

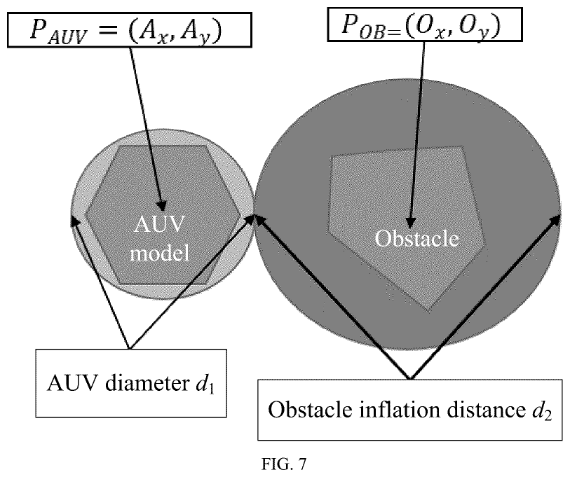

Then, a limit distance is defined. A diameter of an AUV model is defined, which is specifically diameter d₁ of a smallest circle centered on a geometric center P_{AUV}=(Aₓ, A_{y}) of the AUV model and covering the AUV model. An inflation distance of the obstacle is defined, which is a distance extending outwards from the obstacle. Therefore, the inflation distance of the obstacle is defined as d₂. A radius of a smallest circle centered on P_{OB}=(Oₓ, O_{y}) and covering the obstacle is defined as r₁. A radius of the AUV model is defined as r₂, d₂=r₁+r₂. The inflation distance is set to leave some room for the DWA algorithm to run. If there is no such distance, when the operation switches from the 3D-DBH-RRT* algorithm to the DWA algorithm, the AUV may not be able to turn in time and may collide with the obstacle. As shown in FIG. 7, the limit distance is expressed as:

$$\sqrt{{( {A}_{x} - {O}_{x} )}^{2} + {( {A}_{y} - {O}_{y} )}^{2}} = \frac{{d}_{1} + {d}_{2}}{2}$$

The 3D-DBH-RRT* algorithm is described as follows.

The 3D-DBH-RRT* algorithm is initialized.

Before the rescue-side AUV departs, the algorithm is run for a period of time for the following purposes: (1) to find a feasible path from the rescue-side AUV to the demand-side AUV; and (2) to continuously optimize the path to approach a shortest path. The rescue-side AUV and the demand-side AUV share map and path information to maintain algorithm efficiency.

The 3D-DBH-RRT* algorithm deployed on the rescue-side AUV is described below.

The position of the rescue-side AUV is constantly changing and the dynamic obstacle underwater is likely to block the planned path. Therefore, when the path planned by the rescue-side AUV encounters an obstacle, the path is re-planned with a current coordinate as a starting point and the demand-side AUV as an endpoint. Since the initialization operation has already been completed, this step will not take too much time. If no feasible path is found before the rescue-side AUV reaches the obstacle, then the DWA algorithm is executed to achieve dynamic obstacle avoidance. If a feasible path is found, it replaces the original path.

The 3D-DBH-RRT* algorithm deployed on the demand-side AUV is described below.

The battery level of the demand-side AUV is relatively low. Therefore, the demand-side AUV runs this algorithm only when the rescue-side AUV reaches a rescue radius (the maximum distance that the demand-side AUV continues to move based on a current battery level thereof). As such, the algorithm activates the power-saving mode. When running the algorithm, the demand-side AUV needs to maintain the same short path as the rescue-side AUV, that is, to synchronize the map and path information with the rescue-side AUV.

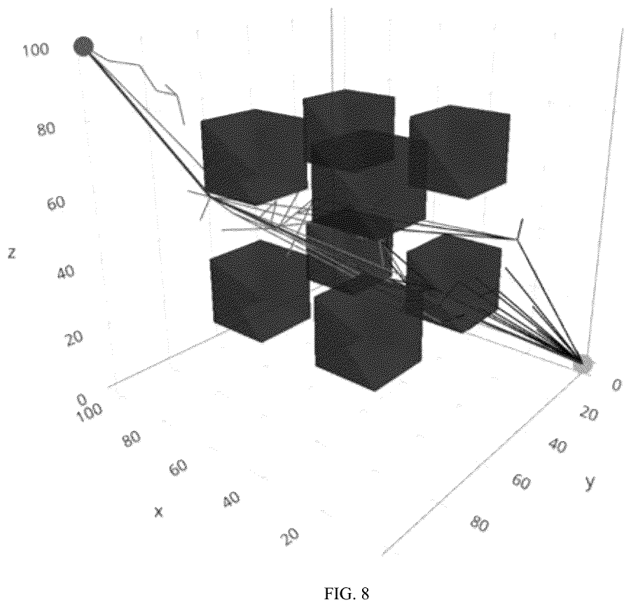

The effect of the 3D-DBH-RRT* algorithm is shown in FIG. 8.

The present disclosure proposes a wireless charging-based underwater energy rescue method for an AUV cluster. The present disclosure is based on decoupling representation and fully considers the actual situation of the AUV rescue system. For example, the rescue-side AUV takes speed as a constraint in order for rapid rescue, while the demand-side AUV takes minimum energy consumption as a constraint to select the optimal charging point. In addition, optimal path planning is performed in environments with dynamic disturbances such as fish schools. The present disclosure combines path planning algorithms RRT* and DWA to achieve rapid and effective underwater energy rescue of AUVs.

The above described are merely preferred embodiments of the present disclosure, and are not intended to limit the protection scope of the present disclosure. Any modifications, equivalent substitutions, and improvements made within the spirit and scope of the present disclosure should fall within the protection scope of the present disclosure.

What is claimed is:

1. A wireless charging-based underwater energy rescue method for an autonomous underwater vehicle (AUV) cluster, comprising the following steps:
S1: issuing, by a demand-side AUV, a charging request through a device of the demand-side AUV;
S2: extracting, by a cloud controller, information of the demand-side AUV, wherein the information of the demand-side AUV comprises a first underwater geographic location, a first estimated mileage to a destination, and a first travel efficiency;
S3: retrieving, by the cloud controller, information of a rescue-side AUV that is at a certain distance from the demand-side AUV and allowed to provide a charging service, based on a location of the demand-side AUV, wherein the information of the rescue-side AUV comprises a second underwater geographic location, a second estimated mileage, a second travel efficiency, and battery information;
S4: calculating a distance between the demand-side AUV and each rescue-side AUV in a sample;
S5: calculating energy required by the demand-side AUV;
S6: calculating a difference between energy available from the rescue-side AUV and the energy required by the demand-side AUV;
S7: selecting a sample of all rescue-side AUVs with an energy difference greater than 0 as a candidate sample of rescue-side AUVs; and
S8: performing global path planning through a three-dimensional dynamic bidirectional heuristic rapidly-exploring random trees (3D-DBH-RRT*) algorithm, and performing local path planning through a dynamic window approach (DWA) algorithm, to achieve real-time obstacle avoidance and find an optimal rescue path.

2. The wireless charging-based underwater energy rescue method for the AUV cluster according to claim 1, wherein in step S2, the information of the demand-side AUV further comprises: a battery level required by the demand-side AUV to reach the destination, and a serial number, a speed, and an attitude of the demand-side AUV.

3. The wireless charging-based underwater energy rescue method for the AUV cluster according to claim 1, wherein in step S3, the information of the rescue-side AUV further comprises: a battery level available from the rescue-side AUV, and a serial number, a speed, and an attitude of the rescue-side AUV.

4. The wireless charging-based underwater energy rescue method for the AUV cluster according to claim 1, wherein in step S8, the step of performing global path planning through the 3D-DBH-RRT* algorithm comprises: running an RRT* algorithm with the rescue-side AUV as a starting point and the demand-side AUV as an endpoint, then, running the RRT* algorithm again with the demand-side AUV as a starting point and the rescue-side AUV as an endpoint, and adding a heuristic function to quickly find a feasible path and continuously optimizing the path to approach a shortest path; wherein map and path information is shared between the rescue-side AUV and the demand-side AUV.

5. The wireless charging-based underwater energy rescue method for the AUV cluster according to claim 1, wherein step S8 further comprises: deploying the DWA algorithm on the demand-side AUV and the rescue-side AUV, respectively, wherein the DWA algorithm deployed on the rescue-side AUV comprises a rapid mode and a power-saving mode; the DWA algorithm deployed on the demand-side AUV comprises a power-saving mode and is only run when no new feasible path within a limit distance between the demand-side AUV and the rescue-side AUV is found through the 3D-DBH-RRT* algorithm; and the limit distance is expressed as:
$$\sqrt{{( {A}_{x} - {O}_{x} )}^{2} + {( {A}_{y} - {O}_{y} )}^{2}} = \frac{{d}_{1} + {d}_{2}}{2}$$
wherein d₁ denotes a diameter of an AUV model, and is a diameter of a first smallest circle, wherein the first smallest circle is centered on a geometric center P_{AUV}=(Aₓ, A_{y}) of the AUV model and covers the AUV model; d₂ denotes an inflation distance of an obstacle, d₂=r₁+r₂; r₁ denotes a radius of a second smallest circle, wherein the second smallest circle is centered on P_{OB}=(Oₓ, O_{y}) and covers the obstacle; and r₂ denotes a radius of the AUV model.

6. The wireless charging-based underwater energy rescue method for the AUV cluster according to claim 1, wherein in step S8, the 3D-DBH-RRT* algorithm deployed on the rescue-side AUV comprises: re-planning a path with a current coordinate as a starting point and the demand-side AUV as an endpoint when a path planned by the rescue-side AUV encounters an obstacle; running, when no feasible path is found before the rescue-side AUV reaches the obstacle, the DWA algorithm to achieve dynamic obstacle avoidance; and replacing an original path when a feasible path is found.

7. The wireless charging-based underwater energy rescue method for the AUV cluster according to claim 6, wherein the 3D-DBH-RRT* algorithm is initialized before the rescue-side AUV departs.

8. The wireless charging-based underwater energy rescue method for the AUV cluster according to claim 1, wherein in step S8, the 3D-DBH-RRT* algorithm deployed on the demand-side AUV comprises: activating the power-saving mode; moving the demand-side AUV only when the demand-side AUV is within a rescue radius of the rescue-side AUV; and synchronizing map and path information between the demand-side AUV and the rescue-side AUV, wherein the rescue radius is denoted as
$$s = V \frac{W}{P} ;$$
W denotes a current battery level of the rescue-side AUV; P denotes a minimum power; and V denotes a speed corresponding to the minimum power.
